(19) United States
(12) Patent Application Publication
(10) Pub. No.: US 2026/0092554 A1
(43) Pub. Date: Apr. 2, 2026

(54) CRANKCASE SCAVENGED TWO-STROKE ENGINE AND HANDHELD POWER TOOL

(71) Applicant: HUSQVARNA AB, Huskvarna (SE)

(72) Inventor: Niklas ENANDER, Goteborg (SE)

(21) Appl. No.: 19/110,875

(22) PCT Filed: Sep. 29, 2023
(86) PCT No.: PCT/SE2023/050972

§ 371 Date: Mar. 12, 2025

(30) Foreign Application Priority Data
Sep. 30, 2022 (SE) 2251133-1

(51) Int. Cl. F02B 25/14; F02B 33/04; F02B 63/02; F02M 69/10

(52) U.S. Cl. CPC F02B 25/14; F02B 33/04; F02B 63/02; F02M 69/10

(57) ABSTRACT

A crankcase scavenged two-stroke engine (1) is disclosed comprising a cylinder (2), a crankcase (5), a crankshaft (10), and a piston (3). The piston (3) comprises a first face (F1) forming a delimiting surface of a combustion chamber (4) and a second face (F2) forming a delimiting surface of a crankcase volume (V). The engine (1) comprises a pump chamber (8) with an aperture (18) 2024/072312 facing the second face (F2) of the piston (3). The piston (3) comprises a section (13) configured to protrude into the pump chamber (8) via the aperture (18) to delimit the pump chamber (8) from the crankcase volume (V) when the piston (3) is at a predetermined position between the top dead centre and the bottom dead centre. The present disclosure further relates to a handheld power tool (20).

### TECHNICAL FIELD

The present disclosure relates to a crankcase scavenged two-stroke engine. The present disclosure further relates to a handheld power tool comprising a crankcase scavenged two-stroke engine.

### BACKGROUND

A two-stroke engine is a type of internal combustion engine which completes a power cycle with two strokes of the piston during only one crankshaft revolution. The uppermost position of a piston in a cylinder is usually referred to as the top dead centre and the lowermost position of the piston in the cylinder is usually referred to as the bottom dead centre. Compared to four-stroke engines, two-stroke engines have a greatly reduced number of moving parts, and consequently can be made more compact and significantly lighter. Therefore, two-stroke petrol engines are used in applications where mechanical simplicity, light weight, and high power-to-weight ratio are main concerns. Typical applications are handheld power tools, tools such as chainsaws, power cutters, hedge trimmers, leaf blowers, multi-tools, or the like.

Most small sized two-stroke engines are crankcase-scavenged engines meaning that these engines use the area below the piston as a charging pump to build up pressure in the crankcase during the power stroke of the piston. Normally, crankcase scavenged two-stroke engines comprise an air inlet connected to the crankcase, wherein air, or an air/fuel mixture, is sucked into the crankcase upon movement of the piston towards the top dead centre. Traditionally, two-stroke engines have been provided with a carburettor arranged at the air inlet for supplying an air/fuel mixture to the crankcase.

In the power stroke of a two-stroke engine, the increased pressure and temperature in the cylinder obtained by the combustion of fuel is partially converted into mechanical work supplied to a crankshaft of the engine. At the same time, the pressure in the crankcase increases as a result of the movement of the piston towards the bottom dead centre.

An exhaust port arranged in the cylinder wall is opened to allow exhaust gases to flow out from the cylinder when the piston reaches a first position relative the cylinder in its movement towards the bottom dead centre. The piston continues the movement towards the bottom dead centre and when it reaches a second position, below the first position, an inlet port arranged in the cylinder wall is opened. The inlet port is fluidly connected to the crankcase via a scavenging channel. The air/fuel mixture in the crankcase is forced to flow into the cylinder via the inlet port by the overpressure in the crankcase.

Accordingly, as understood from the above, in this type of engine, the exhaust port, and the inlet port in the cylinder are open simultaneously in the scavenging phase of the engine, i.e., when the piston is in the region of a bottom dead centre. As a result thereof, some air/fuel mixture may flow through the cylinder from the inlet port to the exhaust port in the scavenging phase. Therefore, a problem associated with small sized two-stroke engines is emission of unburned hydrocarbon, i.e., emission of unburned fuel. Moreover, a general problem with crankcase scavenged two-stroke engines is that the use of the pressure pulsations in the crankcase volume puts limitations on the scavenging of the engine, i.e., the supply of fresh air and fuel to the combustion chamber and the transfer of exhaust gas from the combustion chamber.

As mentioned, traditionally, two-stroke engines have been provided with a carburettor arranged at the air inlet of the engine to supply an air/fuel mixture to the crankcase. However, development has led to fuel injection systems comprising a fuel injector for injecting fuel into one or more of the crankcase, the air inlet, and the transfer duct. Fuel injection systems provides several advantages over carburettors, among them a simpler and more robust design, a higher controllability of the amount of injected fuel and the possibility to inject fuel closer to the combustion chamber to obtain a better response of the engine. The amount of supplied fuel affects the air/fuel ratio which is commonly referred to as the lambda value. In turn, the air/fuel ratio affects many aspects of an engine, including the fuel efficiency, the combustion temperature, the emission levels, and the startability, i.e., the ability of the engine to start. However, fuel injection systems of crankcase scavenged two stroke engines are also associated with some problems, drawbacks, and design difficulties.

One problem associated with fuel injection systems of crankcase scavenged two-stroke engines is that it is difficult to obtain high fuel injection pressures without significantly adding complexity, costs, and weight to the engine. As indicated above, crankcase scavenged two-stroke engines are normally used in applications in which mechanical simplicity, light weight, and high power-to-weight ratio are main concerns. Moreover, on today's consumer market, it is an advantage if products comprise different features and functions while the products have conditions and/or characteristics suitable for being manufactured and assembled in a cost-efficient manner.

A high fuel injection pressure is advantageous over a low fuel injection pressure for several reasons. One reason is that higher fuel injection pressures can provide finer fuel sprays for better atomization of the fuel and thereby also an improved mixing between the fuel and the air as compared to lower fuel injection pressures. An improved mixing between the fuel and the air can reduce the fuel consumption and the emissions from the engine. Another reason is that low fuel injection pressures put limitations on the locations of the engine in which fuel can be injected in a proper manner. That is, in order to obtain adequately developed fuel sprays, the fuel injection pressure has to be sufficiently greater than the pressure in the space in which the fuel is injected. Therefore, in crankcase scavenged two-stroke engines comprising a low-pressure fuel injection system, the fuel is normally injected into the crankcase when the piston is in a region of the top dead centre, i.e., when the pressure inside the crankcase volume is minimized, and/or is injected into an air inlet of the engine.

As understood from the above, since the injection of fuel is limited by the pressure in the space in which the fuel is injected, the use of low fuel injection pressures also limits the control of the fuel injection timing and the fuel injection duration. Furthermore, fuel injection systems operating at lower fuel injection pressures are also more sensitive to fuel temperature than fuel injection systems operating at higher fuel injection pressures.

A fuel injection system of a crankcase scavenged two-stroke engine normally comprises a membrane fuel pump powered by the pressure pulsations in the crankcase. That is, in more detail, such a membrane fuel pump normally comprises a flexible membrane having a first side fluidly connected to the crankcase and a second side forming a delimiting surface of a fuel pump chamber for pumping fuel from a fuel tank to a fuel injector of the fuel supply system. Such membrane fuel pumps are mechanical simple, light weight, and do not require complex, costly, and heavy additional arrangements and systems, such as electrical power supply systems, and the like. Moreover, such membrane fuel pumps are normally able operate in an efficient manner regardless of the orientation of the engine relative to the gravitational field. However, the pumping action thereof is limited to the size of the pressure pulsations in the crankcase.

Moreover, some crankcase scavenged two-stroke engines have been developed comprising a fuel supply system with a fuel injector configured to inject fuel directly into the combustion chamber. Such fuel supply systems are capable of lowering the fuel consumption and the emission levels from the engine. One reason for this is that the fuel injector can be controlled such that a main injection of fuel is performed when the inlet and exhaust ports are closed which can lower the emission of unburned hydrocarbon from the engine. However, the injection of fuel directly into the combustion chamber requires significantly higher fuel injection pressures than when injecting fuel into other spaces of the engine, such as the crankcase, the air inlet, or the scavenging channel, and as mentioned, high fuel injection pressures normally require the addition of complex, costly, and heavy additional arrangements, and systems, such as electrical power supply systems, and the like.

### SUMMARY

It is an object of the present invention to overcome, or at least alleviate, at least some of the above-mentioned problems and drawbacks.

According to a first aspect of the invention, the object is achieved by a crankcase scavenged two-stroke engine comprising a cylinder, a crankcase enclosing a crankcase volume, and a crankshaft arranged at least partially inside the crankcase volume. The engine further comprises a piston connected to the crankshaft such that the piston reciprocates in the cylinder between a top dead centre and a bottom dead centre upon rotation of the crankshaft. The piston comprises a first face forming a delimiting surface of a combustion chamber and a second face forming a delimiting surface of the crankcase volume. The engine comprises a pump chamber with an aperture facing the second face of the piston. The pump chamber is in direct fluid communication with the crankcase volume via the aperture when the piston is in a region of the top dead centre. The piston comprises a section configured to protrude into the pump chamber via the aperture to delimit the pump chamber from the crankcase volume when the piston is at a predetermined position between the top dead centre and the bottom dead centre.

Since the engine comprises the pump chamber, and since the piston comprises the section configured to protrude into the pump chamber via the aperture to delimit the pump chamber from the crankcase volume when the piston is at the predetermined position, a fluid pressure inside the pump chamber can be obtained being significantly higher than a peak pressure obtained in the crankcase volume upon rotation of the crankshaft.

That is, since the pump chamber is delimited from the crankcase volume by the section of the piston when the piston is at the predetermined position, the movement of the piston from the predetermined position towards the bottom dead centre can be utilized to obtain peak fluid pressures inside the pump chamber being significantly higher than peak pressures obtained in the crankcase volume. In other words, conditions are provided for significantly greater pressure pulsations in the pump chamber as compared to the pressure pulsations in the crankcase volume.

Accordingly, a crankcase scavenged two-stroke engine is provided in which high fluid pressures can be obtained in a simple and cost-efficient manner without significantly adding weight to the engine. The high fluid pressure inside the pump chamber can be used to assist fluid transport in a fuel supply system of the engine, and/or in a scavenging system of the engine. Accordingly, due to the features of the engine, conditions are provided for a fuel supply system operating at higher fuel injection pressures without significantly adding complexity, costs, and weight to the engine. Moreover, due to the features of the engine, conditions are provided for an engine with a more efficient scavenging process.

Moreover, since the pump chamber is in direct fluid communication with the crankcase volume via the aperture when the piston is in a region of the top dead centre, a mechanically simple solution is provided for obtaining high fluid pressures in the engine. Furthermore, since the pump chamber is in direct fluid communication with the crankcase volume via the aperture when the piston is in a region of the top dead centre, a pressure increase can be obtained inside the pump chamber by the movement of the piston from the top dead centre to the predetermined position before the pump chamber is delimited from the crankcase volume. As a result, the pump chamber can be utilized to pump fluid, and/or to obtain great pressure pulsations, in a further efficient manner.

Accordingly, a crankcase scavenged two-stroke engine is provided overcoming, or at least alleviating, at least some of the above-mentioned problems and drawbacks. As a result, the above-mentioned object is achieved.

Optionally, the pump chamber is in direct fluid communication with the crankcase volume via the aperture when the piston is at a position between the top dead centre and the predetermined position. In this manner, a pressure increase is obtained inside the pump chamber by the movement of the piston from the top dead centre to the predetermined position before the pump chamber is delimited from the crankcase volume. As a result, the pump chamber can be utilized to pump fluid in a further efficient manner and even higher peak pressures inside the pump chamber can be obtained.

Optionally, the pump chamber is arranged at a first end of the cylinder. Thereby, a simple, efficient, and reliable solution is provided for obtaining high fluid pressures in a crankcase scavenged two-stroke engine without requiring complex, costly, and heavy additional arrangements, and systems, such as electrical power supply systems, and the like. Moreover, an engine is provided having conditions for being compact.

Optionally, the pump chamber is at least partially formed by a pump chamber body attached to a first end of the cylinder. Thereby, an engine is provided having conditions and characteristics suitable for being manufactured and assembled in a cost-efficient manner, while being able to produce high fluid pressures in a simple, efficient, and reliable manner. Moreover, an engine is provided having conditions for being compact.

Optionally, the pump chamber body is ring-shaped. Thereby, conditions are provided for a non-complex section of the piston for protruding into the pump chamber. As a further result, an engine is provided having conditions and characteristics suitable for being compact and for being manufactured and assembled in a cost-efficient manner.

Optionally, the pump chamber is annular or arc-shaped. Thereby, conditions are provided for a non-complex section of the piston for protruding into the pump chamber. As a further result, an engine is provided having conditions and characteristics suitable for being compact and for being manufactured and assembled in a cost-efficient manner.

Optionally, a radially outer wall of the pump chamber superimposes a radially outer wall of the cylinder as seen in a direction parallel to a cylinder axis of the cylinder. Thereby, conditions are provided for a non-complex pump chamber as well as a non-complex section of the piston for protruding into the pump chamber. As a further result, an engine is provided having conditions and characteristics suitable for being manufactured and assembled in a cost-efficient manner, while being able to produce high fluid pressures.

Optionally, the section of the piston is a section of a piston skirt of the piston. Thereby, conditions are provided for a non-complex pump chamber as well as a non-complex section of the piston for protruding into the pump chamber. As a further result, an engine is provided having conditions and characteristics suitable for being compact and for being manufactured and assembled in a cost-efficient manner, while being able to produce high fluid pressures in a simple, efficient, and reliable manner.

Optionally, the engine comprises a channel connected to the pump chamber, and wherein the section of the piston is configured to force gas from the pump chamber through the channel upon movement of the piston from the first predetermined position towards the bottom dead centre. Thereby, an engine is provided in which the gas forced from the pump chamber can be utilized in a system, such as a lubrication system, a fuel supply system and/or a scavenging system, in an efficient and reliable manner.

Optionally, the engine comprises a fuel supply system, and wherein the channel fluidly connects the pump chamber and a portion of the fuel supply system. Thereby, an engine is provided in which the pressure increase inside the pump chamber can be utilized to assist fluid transport in the fuel supply system of the engine. For example, an engine is provided comprising a fuel supply system having conditions for injecting fuel at higher fuel injection pressures without significantly adding cost and complexity of the engine. In this manner, conditions are provided for better atomization of the fuel and thereby also an improved mixing between the fuel and the air. In other words, conditions are provided for a reduced fuel consumption and emissions levels from the engine.

Furthermore, conditions are provided for a fuel supply system injecting fuel into spaces of the engine having higher pressures, such as the combustion chamber of the engine, without requiring complex, costly, and heavy additional arrangements, and systems, such as electrical power supply systems, and the like. Furthermore, conditions are provided for a fuel supply system having improved controllability of the fuel injection timing and the fuel injection duration without significantly adding complexity, costs, and weight to the engine.

Optionally, the fuel supply system comprises a fuel pump, and wherein the portion of the fuel supply system is a portion of the fuel pump. Thereby, an engine is provided comprising a fuel supply system having conditions for injecting fuel at higher fuel injection pressures without significantly adding cost and complexity of the engine. In this manner, conditions are provided for better atomization of the fuel and thereby also an improved mixing between the fuel and the air without significantly adding complexity, costs, and weight to the engine.

Furthermore, conditions are provided for a fuel supply system injecting fuel into spaces of the engine having higher pressures, such as the combustion chamber of the engine, without requiring complex, costly, and heavy additional arrangements, and systems, such as electrical power supply systems, and the like. Furthermore, conditions are provided for a fuel supply system having improved controllability of the fuel injection timing and the fuel injection duration without significantly adding complexity, costs, and weight to the engine.

Optionally, the fuel pump is a membrane pump comprising a flexible membrane, and wherein the portion of the fuel supply system is a portion of the flexible membrane. Thereby, high fuel injection pressures can be obtained in a simple, efficient, and reliable manner, without significantly adding complexity, costs, and weight to the engine.

Optionally, the fuel supply system comprises at least one of a fuel injector configured to inject fuel into the crankcase volume, a fuel injector configured to inject fuel into an air inlet duct connected to the crankcase volume, and a fuel injector configured to inject fuel into a scavenging channel fluidly connecting the crankcase volume and the combustion chamber. Thereby, an engine is provided having conditions for injecting fuel into one or more of these types of spaces at high fuel injection pressures without significantly adding complexity, costs, and weight to the engine.

Optionally, the fuel supply system comprises a fuel injector configured to inject fuel into the combustion chamber. Thereby, a crankcase scavenged two-stroke engine is provided having conditions for a low fuel consumption, low emission levels and high controllability of fuel injection timing and duration, without requiring complex, costly, and heavy additional arrangements, and systems, such as electrical power supply systems, and the like.

Optionally, the engine comprises a lubricant supply system comprising a lubricant pump, and wherein the channel fluidly connects the pump chamber and a portion of the lubricant pump. Thereby, an engine is provided in which the pressure increase inside the pump chamber can be utilized to pump lubricant to portions of the engine and/or to portions of another type of arrangement.

Optionally, the fuel supply system comprises a pressure reservoir, and wherein the portion of the fuel supply system is a portion of the pressure reservoir. Thereby, an engine is provided having condition for generating a high fluid pressure in the pressure reservoir without requiring complex, costly, and heavy additional arrangements, and systems, such as electrical power supply systems, and the like.

Optionally, the channel comprises a non-return valve. Thereby, a simple, efficient, and reliable solution is provided for maintaining a high fluid pressure in the pressure reservoir.

Optionally, the fuel supply system is an air assisted direct injection system configured to inject fuel and air from the pressure reservoir into the combustion chamber of the engine. Thereby, the air assisted direct injection system of the engine can be supplied with pressurized gas without requiring complex, costly, and heavy additional arrangements, and systems, such as electrical power supply systems, and the like. Accordingly, due to the features of the engine, a crankcase scavenged two-stroke engine is provided having conditions for operating in a fuel-efficient manner without requiring complex, costly, and heavy additional arrangements, and systems, such as electrical power supply systems, and the like.

Optionally, the engine comprises a scavenging port in a wall of the cylinder, and a scavenging channel fluidly connecting the pump chamber and the scavenging port. Thereby, a crankcase scavenged two-stroke engine is provided in which air or an air/fuel mixture can be transported to the combustion chamber using a higher driving pressure than what can be obtained by the pressure fluctuations in the crankcase volume. In this manner, conditions are provided for an increased flowrate of gas into the combustion chamber and thereby also an improved scavenging, i.e., an improved supply of fresh air and fuel to the combustion chamber as well as an improved transfer of exhaust gas from the combustion chamber. As a further result, a crankcase scavenged two-stroke engine is provided having conditions for a low fuel consumption and low emission levels, without requiring complex, costly, and heavy additional arrangements, and systems, such as electrical power supply systems, and the like.

According to a second aspect of the invention, the object is achieved by a handheld power tool comprising an engine according to some embodiments of the present disclosure.

Since the handheld power tool comprises an engine according to some embodiments, a handheld power tool is provided in which high fluid pressures can be obtained in a simple and cost-efficient manner without significantly adding weight, costs, and complexity to the handheld power tool.

Accordingly, a handheld power tool is provided overcoming, or at least alleviating, at least some of the above-mentioned problems and drawbacks. As a result, the above-mentioned object is achieved.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 illustrates a handheld power tool, according to some embodiments,

FIG. 2 illustrates a perspective view of an engine of the handheld power tool illustrated in FIG. 1,

FIG. 3 illustrates a cross section of an engine according to the embodiments illustrated in FIG. 2,

FIG. 4 illustrates the cross section of the engine illustrated in FIG. 3 in which a piston of the engine is positioned at a predetermined position located between a top dead centre and a bottom dead centre,

FIG. 5 illustrates the cross section of the engine illustrated in FIG. 3 and FIG. 4 in which the piston is positioned at the bottom dead centre,

FIG. 6 illustrates a perspective view of the piston of the engine explained with reference to FIG. 1-FIG. 5,

FIG. 7 illustrates a perspective view of a pump chamber body of the engine explained with reference to FIG. 1-FIG. 6,

FIG. 8 illustrates an enlarged view of the cross section of the engine illustrated in FIG. 3-FIG. 5,

FIG. 9 illustrates a cross section of an engine according to some further embodiments, and

FIG. 10 illustrates a cross section of an engine according to some further embodiments.

### DETAILED DESCRIPTION

Aspects of the present invention will now be described more fully. Like numbers refer to like elements throughout. Well-known functions or constructions will not necessarily be described in detail for brevity and/or clarity.

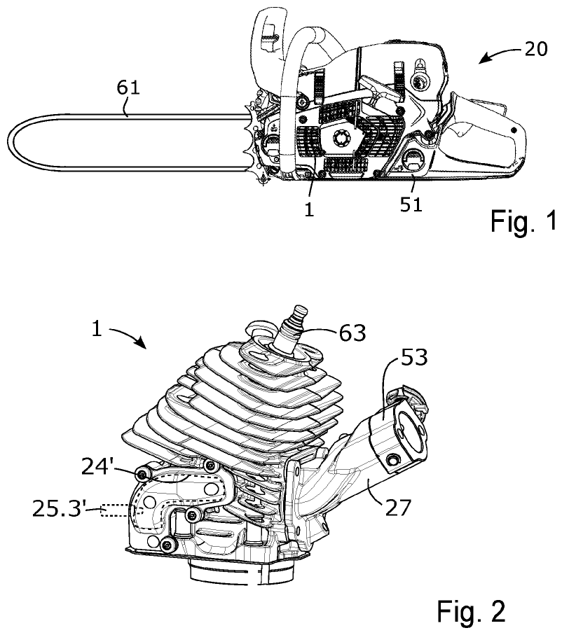

FIG. 1 illustrates a handheld power tool 20, according to some embodiments. The handheld power tool 20 comprises a tool 61 and a crankcase scavenged two stroke internal combustion engine 1 configured to power the tool 61. For reasons of brevity and clarity, the crankcase-scavenged two-stroke internal combustion engine 1 is in some places herein referred to as “crankcase scavenged two stroke engine 1”, “the two-stroke engine 1”, and “the engine 1”.

According to the illustrated embodiments, the handheld power tool 20 is a chainsaw comprising a tool 61 in the form of a cutting chain. According to further embodiments, the handheld power tool 20 may be another type of handheld power tool 20, such as a power cutter, a hedge trimmer, a leaf/debris blower, a multi-tool, or the like. The wording “handheld”, as used herein, means that the power tool 20 is portable and is configured to be supported by one or two hands of a user during operation of the power tool 20. The handheld power tool 20 is in some places herein referred to as the “power tool 20” for reasons of brevity and clarity.

The engine 1 of the handheld power tool 20 may be configured to run on gasoline, also referred to as petrol, alcohol, similar volatile fuels, or combinations thereof. In FIG. 1, a fuel tank 51 of the handheld power tool 20 is indicated. The fuel tank 51 may thus be configured to store and supply such a fuel to the engine 1 of the power tool 20 as is also further explained herein.

FIG. 2 illustrates a perspective view of the engine 1 of the handheld power tool 20 illustrated in FIG. 1. In FIG. 2, a crankcase of the engine 1 has been omitted for reasons of brevity and clarity.

As mentioned, according to the illustrated embodiments, the engine 1 is configured to power a tool of a handheld power tool. However, according to further embodiments, the engine 1, as referred to herein, may be configured to power another type of device, arrangement, or system, than a tool of a handheld power tool. According to embodiments herein, the engine 1 is a small sized crankcase-scavenged two-stroke engine 1. The term “small sized” in this context may encompass that the engine 1 has an engine displacement less than 250 cubic centimetres.

In FIG. 2, some components of the engine 1 is visible, such as a spark plug 63, a throttle body 53, an air inlet duct 27, and a scavenging channel 24′. The function and features of these components will be further explained in the following.

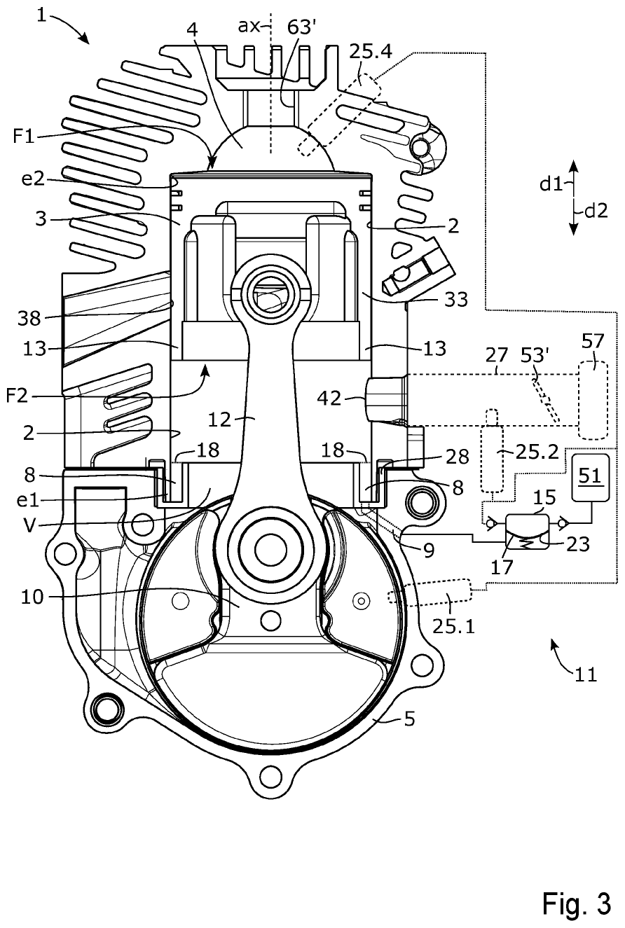

FIG. 3 illustrates a cross section of an engine 1 according to the embodiments illustrated in FIG. 2. The engine 1 comprises a cylinder 2 and a piston 3 configured to reciprocate in the cylinder 2. Moreover, the engine 1 comprises a crankcase 5. The crankcase 5 encloses a crankcase volume V. The engine 1 further comprises a crankshaft 10 arranged at least partially inside the crankcase volume V. According to the illustrated embodiments, the engine 1 comprises a crankshaft 10 with a portion extending through the crankcase volume V.

The engine 1 comprises a connecting rod 12 connecting the piston 3 to the crankshaft 10 such that the piston 3 reciprocates in the cylinder 2 along a cylinder axis ax of the cylinder 2 between a bottom dead centre and a top dead centre upon rotation of the crankshaft 10. In FIG. 2, the piston 3 is illustrated in the top dead centre.

The piston 3 comprises a first face F1 forming a delimiting surface of a combustion chamber 4 and a second face F2 forming a delimiting surface of the crankcase volume V. In FIG. 3, a spark plug hole 63′ of the engine 1 is indicated. The spark plug hole 63′ may comprise internal threads configured to engage with external threads of a spark plug, such as the spark plug 63 illustrated in FIG. 2. As understood from above, the first face F1 of the piston 3 faces the spark plug hole 63′ and the combustion chamber 4. The second face F2 of the piston 3 faces the crankcase 5 of the engine 1.

The cylinder 2 of the engine 1 comprises air inlet port 42. The air inlet port 42 fluidly connects the crankcase 5 to the air inlet duct 27 when the piston is in a region of the top dead centre as can be seen in FIG. 3. The air inlet duct 27 is provided with a throttle 53′. The amount of air sucked into the crankcase 5 can be regulated by regulating an opening degree of the throttle 53′, as is further explained herein. Moreover, in FIG. 3, an air filter 57 is schematically indicated.

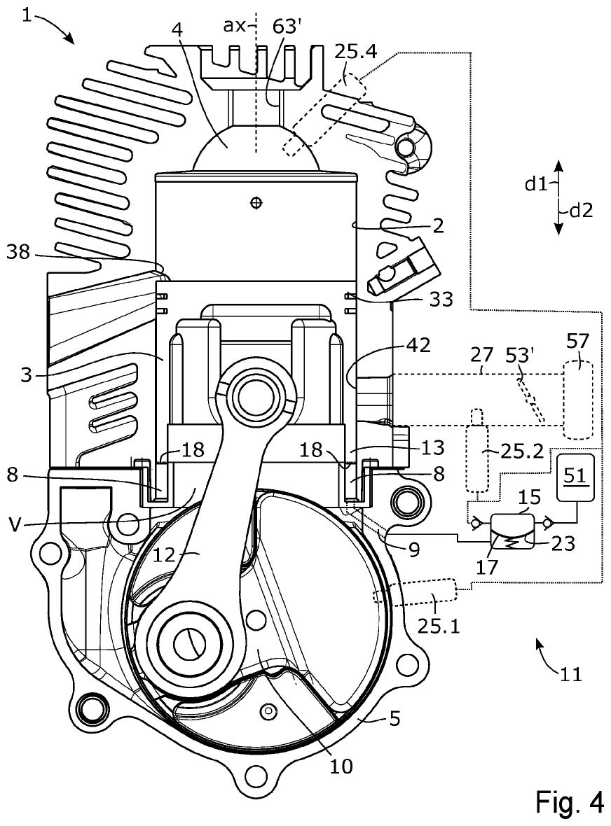

FIG. 4 illustrates the cross section of the engine 1 illustrated in FIG. 3 in which the piston 3 has moved from the top dead centre to a predetermined position located between the top dead centre and the bottom dead centre.

As can be seen in FIG. 4, the air inlet port 42 is closed by a mantle surface of the piston 3 upon movement of the piston 3 in a direction d2 from the top dead centre towards the predetermined position illustrated in FIG. 4. In the following, simultaneous reference is made to FIG. 1-FIG. 4, if not indicated otherwise. As mentioned, the second face F2 of the piston 3 forms a delimiting surface of the crankcase volume V. Accordingly, the size of the crankcase volume V decreases upon movement of the piston 3 in the direction d2 towards the bottom dead centre. In this manner, the pressure inside the crankcase volume V of the crankcase 5 can be increased upon movement of the piston 3 towards the bottom dead centre.

According to the illustrated embodiments, the air inlet port 42 is provided in a wall of the cylinder 2 and a pressure increase is obtained in the crankcase volume V of the crankcase 5 upon movement of the piston 3 in the direction d2 towards the bottom dead centre due to the closing of the air inlet port 42 by the mantle surface of the piston 3. However, according to further embodiments, the air inlet duct 27 may be connected directly to the crankcase 5 and the engine 1 may lack an air inlet port 42 provided in a wall of the cylinder 2. According to such embodiments, as well as in other embodiments herein, the engine 1 may comprise one or more one-way valves, such as reed valves, arranged to hinder a flow of gas from the crankcase volume V of the crankcase 5 to the inlet duct 27 upon movement of the piston 3 towards the bottom dead centre.

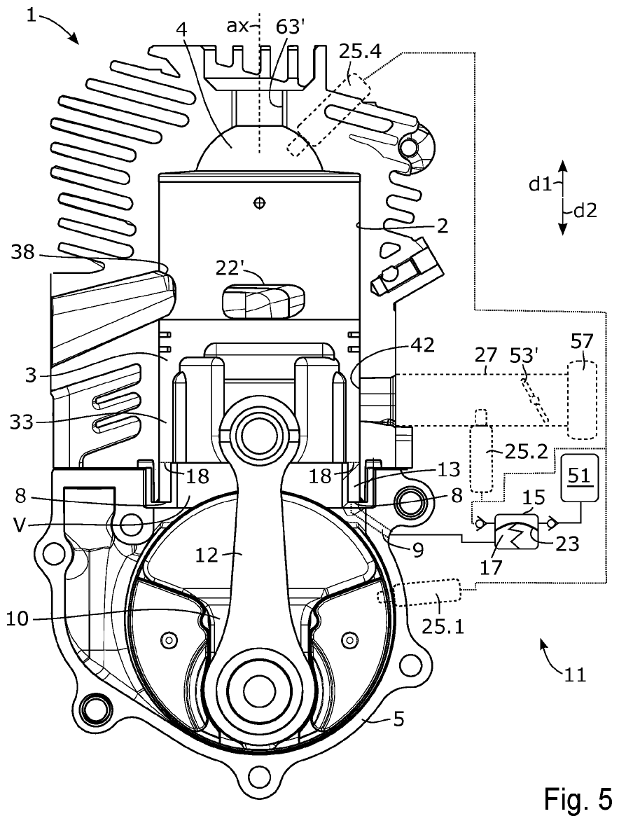

FIG. 5 illustrates the cross section of the engine 1 illustrated in FIG. 3 and FIG. 4 in which the piston 3 has moved to the bottom dead centre. As understood from the above described, since the second face F2 of the predetermined position delimits the crankcase volume V, the size of the crankcase volume V is at a minimum when the piston 3 is at the bottom dead centre. Likewise, the size of the crankcase volume V is at a maximum when the piston 3 is at the top dead centre as illustrated in FIG. 3. Below, simultaneous reference is made to FIG. 1 FIG. 5, if not indicated otherwise.

As seen in FIG. 5, the engine 1 comprises an inlet port 22′ provided in a wall of the cylinder 2. The scavenging channel 24′ of the engine 1 indicated in FIG. 2 fluidly connects the crankcase volume V of the crankcase 5 and the inlet port 22′. According to the illustrated embodiments, the inlet port 22′ is open when the piston 3 is in a region of the bottom dead centre. In more detail, according to the illustrated embodiments, the inlet port 22′ is closed by a mantle surface of the piston 3 when the mantle surface of the piston 3 is above an upper edge of the inlet port 22′, wherein the inlet port 22′ is opened, i.e., uncovered, when the mantle surface of the piston 3 is moved in the direction d2 towards the bottom dead centre and reaches a position in which the mantle surface of the piston 3 is below the upper edge of the inlet port 22′. The term “upper edge” as used herein means an edge of the inlet port 22′ being the uppermost edge if the engine is oriented relative to a local gravity field such that the direction d2 from the top dead centre towards the bottom dead centre coincides with a local gravity vector. Obviously, the engine 1 may be configured to operate at other orientations relative to a local gravity field.

As understood from the above, when the inlet port 22′ is opened, a transport of gas, such as air or an air/fuel mixture, is obtained from the crankcase volume V of the crankcase 5 into the combustion chamber 4 via the scavenging channel 24′ indicated in FIG. 2 and the inlet port 22′ indicated in FIG. 5. The engine 1 may comprise more than one inlet port 22′ and more than one scavenging channel 24′.

Furthermore, as is seen in FIG. 3-FIG. 5, the engine 1 comprises an exhaust port 38 provided in a wall of the cylinder 2. The exhaust port 38 may be fluidly connected to an exhaust system of the engine 1. As is best seen in FIG. 5, the inlet port 22′ and the exhaust port 38 are configured such that an upper edge of the exhaust port 38 is above the upper edge of the inlet port 22′.

The feature that the upper edge of the exhaust port 38 is above the upper edge of the inlet port 22′ means that an uppermost edge of the exhaust port 38 is located above the uppermost edge of the inlet port 22′ as seen relative to a local gravity vector when the engine 1 is oriented relative to a local gravity field such that the direction d2 from the top dead centre towards the bottom dead centre coincides with the local gravity vector.

Accordingly, due to these features, the inlet port 22′ becomes fully closed prior to the exhaust port 38 upon movement of the piston 3 from the bottom dead centre towards the top dead centre. When each of the inlet port 22′ and the exhaust port 38 is fully closed, the gas trapped inside the combustion chamber 4 is compressed by the movement of the piston 3 towards the top dead centre.

According to embodiments herein, the engine 1 may comprise one or more of a fuel injector 25.1 configured to inject fuel into the crankcase volume V of the crankcase 5, a fuel injector 25.2 configured to inject fuel into the inlet duct 27 connected to the crankcase volume V of the crankcase 5, and a fuel injector 25.4 configured to inject fuel into the combustion chamber 4. As an alternative, or in addition, the engine 1 may comprise a fuel injector 25.3′ configured to inject fuel into a scavenging channel 24′ fluidly connecting the crankcase volume V and the combustion chamber 4. Such a fuel injector 25.3′ is schematically indicated in FIG. 2.

Thus, fuel added to, or transported to, the combustion chamber 4 from one or more of such fuel injectors 25.1, 25.2, 25.3′, 25.4 may, together with air trapped in the combustion chamber 4, be compressed when each of the inlet port 22′ and the exhaust port 38 is fully closed and the piston 3 moves in the direction d1 towards the top dead centre. The air/fuel mixture may be ignited by a sparkplug 63, for example when the piston 3 is in a region of the top dead centre.

The increased pressure and temperature in the combustion chamber 4 resulting from the combustion therein forces the piston 3 in the direction d2 towards the bottom dead centre.

This force on the piston 3 can be converted into mechanical work supplied to the crankshaft 10 of the engine 1. Due to the arrangement of the exhaust port 38 and the inlet port 22′, the exhaust port 38 is opened earlier than the inlet port 22′ upon movement of the piston 3 in the direction d2 towards the bottom dead centre. In this manner, exhaust gas can be expelled from the combustion chamber 4 to an exhaust system before fresh air is transported into the combustion chamber 4 via the scavenging channel 24′ and the inlet port 22′ by the pumping action obtained from the the movement of the piston 3 towards the bottom dead centre.

As indicated, the size of the crankcase volume V is at a minimum when the piston 3 is at the bottom dead centre and the size of the crankcase volume V is at a maximum when the piston 3 is at the top dead centre because the second face F2 of the piston 3 forms a delimiting surface of the crankcase volume V of the crankcase 5. Thus, the piston 3 of the engine 1 according to embodiments herein acts like a scavenging pump member, i.e., a pump member for replacing combustion gas inside the combustion chamber 4 of the engine 1.

As can be seen in FIG. 3-FIG. 5, according to embodiments herein, the engine 1 comprises a pump chamber 8. As is indicated in FIG. 3, the pump chamber 8 has an aperture 18 which faces the second face F2 of the piston 3. The pump chamber 8 may also be referred to as a supplementary pump chamber. Moreover, as seen in FIG. 3, the pump chamber 8 is in direct fluid communication with the crankcase volume V via the aperture 18 when the piston 3 is in a region of the top dead centre. The feature that the pump chamber 8 is in direct fluid communication with the crankcase volume V via the aperture 18 means that aperture 18 forms a boundary between the pump chamber 8 and the crankcase volume V. In other words, molecules, or other type of particles, are free to move between the crankcase volume V and the pump chamber 8 via the aperture 18 in a direct manner, i.e., without passing any other channels or types of formations when passing from the crankcase volume V to the pump chamber 8 and vice versa.

In FIG. 3-FIG. 5, a section 13 of the piston 3 is indicated. As seen in FIG. 4, the section 13 is configured to protrude into the pump chamber 8 via the aperture 18 to delimit the pump chamber 8 from the crankcase volume V when the piston 3 is at the predetermined position between the top dead centre and the bottom dead centre. In this manner, gas, such as air, or an air/fuel mixture, can be compressed inside the pump chamber 8 by the movement of the section 13 of the piston 3 in the direction d2 towards the bottom dead centre. Thereby, a significantly higher compression ratio can be obtained in the pump chamber 8 than what is obtained in the crankcase volume V of the crankcase 5 upon movement of the piston 3 from the top dead centre to the bottom dead centre. The compression ratio obtained in the crankcase 5 by the movement of the piston 3 between the top dead centre and the bottom dead centre is approximately 1:1.7 according to the illustrated embodiments.

As understood from the above, the section 13 of the piston 3 is arranged to not protrude into the pump chamber 8 when the piston is at a position between the top dead centre and the predetermined position illustrated in FIG. 4. Therefore, the pump chamber 8 is in direct fluid communication with the crankcase volume V via the aperture 18 when the piston 3 is at a position between the top dead centre and the predetermined position illustrated in FIG. 4. The section 13 of the piston reaches the aperture 18 of the pump chamber 8, which delimits the pump chamber 8 from the crankcase volume V, when the piston 3 reaches the predetermined position between the top dead centre and the bottom dead centre illustrated in FIG. 4. The gas trapped inside the pump chamber 8 is further compressed upon the further movement of the piston 3 in the direction d2 from the predetermined position illustrated in FIG. 4 to the bottom dead centre illustrated in FIG. 5.

Moreover, as understood from the above, the section 13 is configured to protrude into the pump chamber 8 via the aperture 18 during a movement of the piston 3 from the predetermined position illustrated in FIG. 4 to the bottom dead centre illustrated in FIG. 5, as well as during a movement of the piston 3 from the bottom dead centre to predetermined position illustrated in FIG. 4. In other words, according to the illustrated embodiments, the pump chamber 8 is delimited from the crankcase volume V by the section 13 of the piston 3 during the full movement of the piston 3 from the predetermined position illustrated in FIG. 4 to the bottom dead centre illustrated in FIG. 5 and back to the predetermined position illustrated in FIG. 4.

As can be seen in FIG. 3-FIG. 5, and as is indicated in FIG. 3, according to the illustrated embodiments, the pump chamber 8 is arranged at a first end e1 of the cylinder 2. The wording “cylinder 2” as used herein, is a part of the engine 1 being cylindrical about the cylinder axis ax and a part of the engine 1 configured to accommodate the piston 3. In FIG. 3, a second end e2 of the cylinder 2 is indicated. The second end e2 of the cylinder 2 is opposite to the first end e1 of the cylinder 2 and forms a delimiting surface of the combustion chamber 4. As is indicated in FIG. 3, according to the illustrated embodiments, the pump chamber 8 is at least partially formed by a pump chamber body 28 attached to the first end e1 of the cylinder 2.

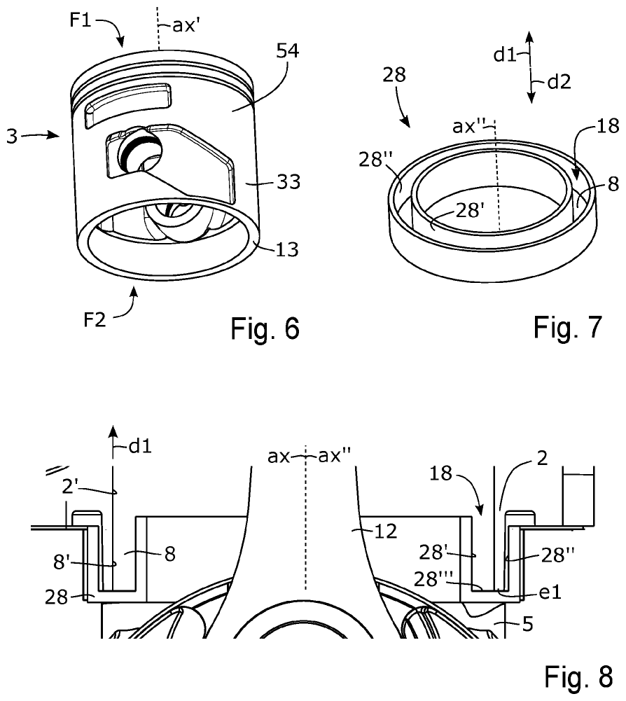

FIG. 6 illustrates a perspective view of the piston 3 of the engine 1 explained with reference to FIG. 1-FIG. 5. Below, simultaneous reference is made to FIG. 1-FIG. 6, if not indicated otherwise. In FIG. 6, a centre axis ax′ of the piston 3 is indicated. Obviously, the piston 3 is arranged such that the centre axis ax′ thereof coincides with the cylinder axis ax of the cylinder 2 of the engine 1 when the piston 3 is arranged in the cylinder 2. The cylinder axis ax of the cylinder 2 of the engine 1 is indicated in FIG. 3-FIG. 5.

Moreover, in FIG. 6, the first face F1 and the second face F2 of the piston 3 are indicated, as well as a mantle surface 54 of the piston 3. As is best seen in FIG. 6, according to the illustrated embodiments, the section 13 of the piston 3 is a section of a piston skirt 33 of the piston 3. Moreover, in these embodiments, the section 13 of the piston 3 is an integral part of the piston 3. However, according to further embodiments, the section 13 of the piston 3 as referred to herein may be another type of section of the piston 3, such as for example a separate unit attached at the second face F2 of the piston 3.

FIG. 7 illustrates a perspective view of the pump chamber body 28 of the engine 1 explained with reference to FIG. 1-FIG. 6. According to the illustrated embodiments, the pump chamber body 28 is formed as a ring-shaped collar having a centre axis ax″. The pump chamber body 28 may be formed by metal or by a polymeric material.

FIG. 8 illustrates an enlarged view of the cross section of the engine 1 illustrated in FIG. 3 FIG. 5. Below, simultaneous reference is made to FIG. 1-FIG. 8, if not indicated otherwise. In FIG. 8, the first end e1 of the cylinder 2 can be seen. According to the illustrated embodiments, the pump chamber body 28 is attached to the first end e1 of the cylinder 2 such that the centre axis ax″ of the pump chamber body 28 coincides with the cylinder axis ax of the cylinder 2.

As is best seen in FIG. 7 and FIG. 8, the pump chamber body 28 comprises a first annular wall 28′ having a surface normal pointing towards the centre axis ax″ of the pump chamber body 28 and a second annular wall 28″ having a surface normal pointing away from the centre axis ax″ of the pump chamber body 28. According to the illustrated embodiments, each of the first and second annular surfaces 28′, 28″ is parallel to the centre axis ax″ of the pump chamber body 28. According to further embodiments, only the first annular wall 28′ of the pump chamber body 28 is parallel to the centre axis ax″ of the pump chamber body 28. Moreover, as is indicated in FIG. 8, the pump chamber body 28 further comprises a third annular surface 28″. The third annular surface 28″ connects the first and second annular surfaces 28′, 28″. According to the illustrated embodiments, the third annular surface 28″ is perpendicular to the centre axis ax″ of the pump chamber body 28, i.e., has a surface normal parallel to the centre axis ax″ of the pump chamber body 28.

Moreover, the pump chamber body 28 is arranged such that the first annular wall 28′ is arranged at a smaller radius from the centre axis ax″ of the pump chamber body 28 than the radius of the cylinder 2 whereas the second annular wall 28″ is arranged at a greater radius from the centre axis ax″ of the pump chamber body 28 than the radius of the cylinder 2. The first, second, and third annular wall 28′, 28″, 28″ together form an annular recess of the pump chamber body 28, wherein the section 13 of the piston 3 is configured to protrude into the annular recess when the piston 3 is at the predetermined position between the top dead centre and the bottom dead centre.

Furthermore, as is best seen in FIG. 8, according to the illustrated embodiments, the second annular wall 28″ forms an attachment surface for attaching the pump chamber body 28 to the first end e1 of the cylinder 2. The pump chamber body 28 may be attached to the first end e1 of the cylinder 2 by being pressed between the crankcase 5 and the cylinder 2. The pump chamber body 28 may be pressed against the first end e1 of the cylinder 2 by tightening fastening elements used for attaching the cylinder 2 to the crankcase 5. Moreover, the engine 1 may comprise one or more sealings and/or gaskets, such as one or more sealings and/or gaskets between the cylinder 2 and the pump chamber body 28 and/or one or more sealings and/or gaskets between the pump chamber body 28 and the crankcase 5.

Moreover, the pump chamber body 28 may be attached to the cylinder 2 in another manner than described above, such as by using separate fastening elements, and/or by welding or crimping the pump chamber body 28 to the first end e1 of the cylinder 2. Furthermore, according to some embodiments, the pump chamber body 28, as referred to herein, may be an integral part of the cylinder 2 of the engine 1. According to such embodiments, the pump chamber body 28 may be provided by machining one piece of material to form the cylinder 2 and the pump chamber body from the one piece of material. Moreover, according to some embodiments, the pump chamber body 28, as referred to herein, may be an integral part of the crankcase 5 of the engine 1. According to such embodiments, the pump chamber body 28 may be provided by machining one piece of material to form the crankcase 5 and the pump chamber body from the one piece of material.

As can be seen in FIG. 7 and FIG. 8, the first annular wall 28′ of the pump chamber body 28 forms a delimiting surface of the pump chamber 8. Moreover, as indicated in FIG. 8, a radially outer wall 8′ of the pump chamber 8 superimposes a radially outer wall 2′ of the cylinder 2 as seen in a direction d1 parallel to a cylinder axis ax of the cylinder 2. In more detail, according to the illustrated embodiments, the radially outer wall 2′ of the cylinder 2 protrudes into the annular recess of the pump chamber body 28 and thereby forms a delimiting surface of the pump chamber 8. Moreover, as seen in FIG. 8, the pump chamber 8 is delimited by a portion of the third annular surface 28′″.

As understood from the above described, according to the illustrated embodiments, the pump chamber 8 is annular. According to further embodiments, the pump chamber 8, as referred to herein, may have another shape, such as an arc-shape, or the like.

According to the embodiments illustrated in FIG. 3-FIG. 5, the engine 1 comprises a channel 9 connected to the pump chamber 8. According to these embodiments, the section 13 of the piston 3 is configured to force gas from the pump chamber 8 through the channel 9 upon movement of the piston 3 from the first predetermined position towards the bottom dead centre.

Moreover, according to the embodiments illustrated in FIG. 3-FIG. 5, the engine 1 comprises a fuel supply system 11, wherein the channel 9 fluidly connects the pump chamber 8 and a portion 17 of the fuel supply system 11. That is, according to these embodiments, the fuel supply system 11 comprises a fuel pump 15, and wherein the portion 17 of the fuel supply system 11 is a portion 17 of the fuel pump 15. In more detail, according to the embodiments illustrated in FIG. 3-FIG. 5, the fuel pump 15 is a membrane pump comprising a flexible membrane 23, and wherein the portion 17 of the fuel supply system 11 is a portion of the flexible membrane 23.

In this manner, the fuel pump 15 can pump fuel from a fuel tank 51 to one or more fuel injectors 25.1, 25.2, 25.3′, 25.4 of the engine 1 using pressure pulsations transferred from the pump chamber 8 to the fuel pump 15 upon reciprocation of the piston 3 between the top dead centre and the bottom dead centre. According to further embodiments, the engine 1 may comprise another type of fuel pump than a membrane pump, wherein the fuel pump is configured to pump fuel from the fuel tank 51 to one or more fuel injectors 25.1, 25.2, 25.3′, 25.4 of the engine 1 using pressure pulsations transferred from the pump chamber 8 to the fuel pump.

In FIG. 3-FIG. 5, a fuel injector 25.1 configured to inject fuel into the crankcase volume V of the crankcase 5 is schematically illustrated as well as a fuel injector 25.2 configured to inject fuel into the inlet duct 27 connected to the crankcase volume V of the crankcase 5.

Moreover, in FIG. 2, a fuel injector 25.3′ configured to inject fuel into a scavenging channel 24′ is schematically indicated. The fuel pump 15 may be operably connected to one or more of such fuel injectors 25.1, 25.2, 25.3′ and may be configured to pump fuel from the fuel tank 51 to one or more of such fuel injectors 25.1, 25.2, 25.3′. Since the channel 9 fluidly connects the pump chamber 8 and the portion 17 of the fuel supply system 11, significantly higher fuel injection pressures can be reached as compared to when using a traditional solution in which pressure pulsations in the crankcase volume V of the crankcase 5 is utilized for pumping fuel.

Due to the significantly higher fuel injection pressures, conditions are provided for better atomization of the fuel and thereby also an improved mixing between the fuel and the air. In other words, conditions are provided for a reduced fuel consumption and emissions levels from the engine 1. Moreover, a solution is provided for obtaining high fuel injection pressures without requiring complex, costly, and heavy additional arrangements, and systems, such as electrical power supply systems, and the like.

In addition, conditions are provided for a fuel supply system 11 injecting fuel into spaces of the engine 1 having higher pressures, such as the combustion chamber 4 of the engine 1, without requiring complex, costly, and heavy additional arrangements, and systems, such as electrical power supply systems, and the like. That is, in FIG. 3-FIG. 5, a fuel injector 25.4 configured to inject fuel directly into the combustion chamber 4 is schematically indicated.

The engine 1 may comprise the fuel injector 25.4 instead of the fuel injectors 25.1, 25.2, 25.3′ referred to above, or may comprise the fuel injector 25.4 in addition to one or more the fuel injectors 25.1, 25.2, 25.3′ referred to above. According to some embodiments, the engine 1 comprises the fuel injector 25.4 configured to inject fuel directly into the combustion chamber 4, as well as a fuel injector 25.1 configured to inject fuel into the crankcase volume V and/or a fuel injector 25.2 configured to inject fuel into the inlet duct 27. In this manner, lubrication of the engine 1, such as the crankshaft 10 thereof, can be ensured without requiring complex, costly, and heavy additional lubrication arrangements.

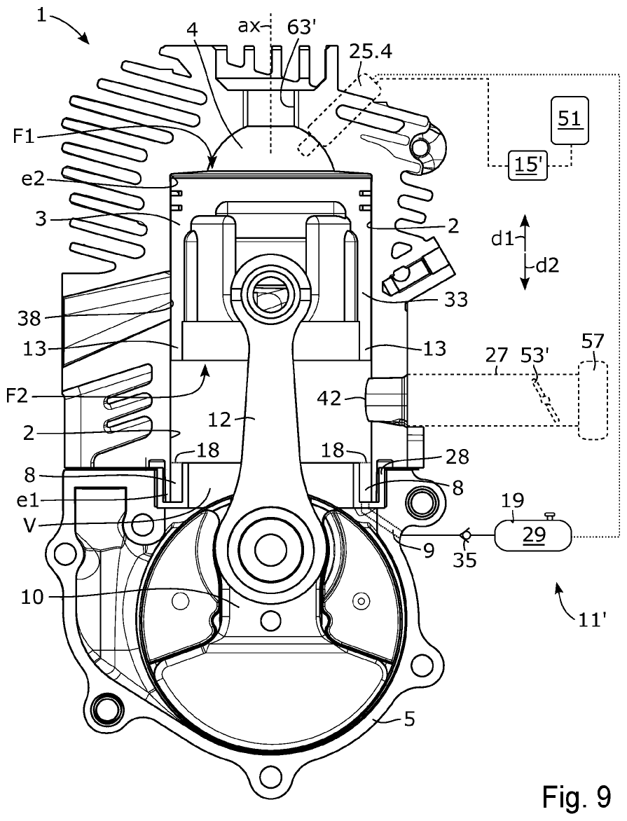

FIG. 9 illustrates a cross section of an engine 1 according to some further embodiments. The engine 1 illustrated in FIG. 9 comprises the same features, functions, and advantages, as the engine 1 explained with reference to FIG. 2-FIG. 8, with some differences explained below. Moreover, the handheld power tool 20 illustrated in FIG. 1 may comprise an engine 1 according to the embodiments illustrated in FIG. 9.

According to the embodiments illustrated in FIG. 9, the engine 1 comprises a pump chamber 8 as explained with reference to FIG. 3-FIG. 8. Moreover, also in FIG. 9, the engine 1 comprises a channel 9 fluidly connecting the pump chamber 8 and a portion 19 of a fuel supply system 11′ of the engine 1. However, according to the embodiments illustrated in FIG. 9, the fuel supply system 11′ comprises a pressure reservoir 29, and wherein the portion 19 of the fuel supply system 11′ is a portion of the pressure reservoir 29. Moreover, the channel 9 comprises a non-return valve 35 configured to allow a flow of gas from the pump chamber 8 to the pressure reservoir 29 and is configured to prevent a flow of gas from the pressure reservoir 29 to the pump chamber 8.

In this manner, a fluid pressure can be obtained in the pressure reservoir 29 being higher than peak pressures obtained in the crankcase volume V of the crankcase 5 during operation of the engine 1 without requiring complex, costly, and heavy additional arrangements, and systems, such as electrical power supply systems, and the like.

According to the embodiments illustrated in FIG. 9, the fuel supply system 11′ is an air assisted direct injection system configured to inject fuel and air from the pressure reservoir 29 into the combustion chamber 4 of the engine 1. That is, as can be seen in FIG. 9, the fuel supply system 11′ comprises a fuel injector 25.4 and a fuel pump 15′ configured to pump fuel to the fuel injector 25.4 from a fuel tank 51, wherein the fuel injector 25.4 is configured to inject fuel from the fuel pump 15′ and air from the pressure reservoir 29 directly into the combustion chamber 4.

Below, simultaneous reference is made to FIG. 1-FIG. 9, if not indicated otherwise. According to some further embodiments, the engine 1, or a handheld power tool 20 comprising the engine 1, may comprise a lubrication system comprising a lubricant pump, wherein the channel 9 is fluidly connected to a portion of the lubricant pump. Accordingly, in such embodiments, the pressure pulsations obtained in the pump chamber 8 can be utilized to pump a lubricant.

Moreover, according to such embodiments, the lubricant pump may be a membrane pump. In other words, the channel 9 may be fluidly connected to a membrane of such a lubricant pump. The lubricant pump may be configured to operate in a similar or corresponding manner as the fuel pump 15 explained with reference to FIG. 3-FIG. 5.

Moreover, such a lubricant pump may be configured to pump lubricant from a lubricant tank to lubrication points adjacent to a tool 61 of a handheld power tool 20 comprising the engine 1. In other words, the lubrication system comprising the lubricant pump may be configured to lubricate the tool 61 of a handheld power tool 20. In this manner, the need for a mechanical pump is circumvented for lubricating the tool 61 which provides conditions for a more compact handheld power tool 20.

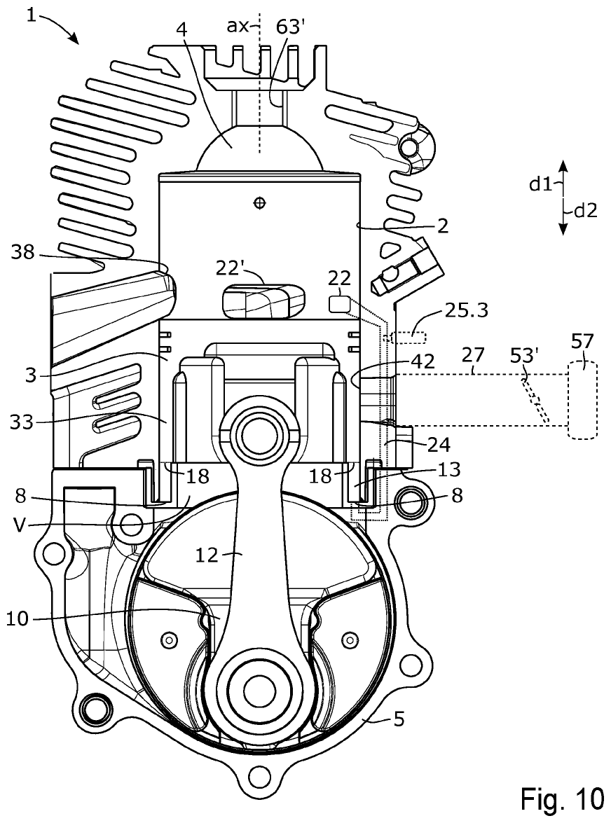

FIG. 10 illustrates a cross section of an engine 1 according to some further embodiments. The engine 1 illustrated in FIG. 10 comprises the same features, functions, and advantages, as the engine 1 explained with reference to FIG. 2-FIG. 8, with some differences explained below. Moreover, the handheld power tool 20 illustrated in FIG. 1 may comprise an engine 1 according to the embodiments illustrated in FIG. 10.

According to the embodiments illustrated in FIG. 10, the engine 1 comprises a pump chamber 8 as explained with reference to FIG. 3-FIG. 8 above. However, in FIG. 10, the engine 1 comprises a scavenging port 22 in a wall of the cylinder 2, and a scavenging channel 24 fluidly connecting the pump chamber 8 and the scavenging port 22. Since the scavenging port 22 is fluidly connected to the pump chamber 8 via the scavenging channel 24, gas will be forced from the pump chamber 8 to the scavenging port 22 when the piston 3 moves to the bottom dead centre.

Due to these features, air, or an air/fuel mixture, can be transported to the combustion chamber 4 using a higher driving pressure than what is obtained by the pressure fluctuations in the crankcase volume. In this manner, conditions are provided for an increased flowrate of gas into the combustion chamber 4 and thereby also an improved scavenging, i.e., an improved supply of fresh air and fuel to the combustion chamber 4.

According to the embodiments illustrated in FIG. 4, the engine 1 comprises a fuel injector 25.3 configured to inject fuel into the scavenging channel 24. According to some embodiments, the engine 1 comprises no further fuel injectors, or fuel supply arrangements, than the fuel injector 25.3 configured to inject fuel into the scavenging channel 24. According to such embodiments, the air inside the crankcase volume V of the crankcase 5 will be at least substantially free of fuel which can provide low emission levels of unburnt hydrocarbon from the engine 1. However, according to further embodiments, the engine 1 may comprise one or more of a fuel injector 25.1, 25.2, 25. 4 as explained with reference to FIG. 3-FIG. 5 and a fuel injector 25.3′ as explained with reference to FIG. 2, in addition to the fuel injector 25.3 illustrated in FIG. 10 or instead of the fuel injector 25.3 illustrated in FIG. 10.

According to some embodiments, the scavenging port 22 and the scavenging channel 24 may be configured such that the gas from the scavenging port 22 is directed towards a top of the combustion chamber 4. Moreover, according to some embodiments, the scavenging port 22 may be positioned at least substantially opposite to the exhaust port 38. In this manner, an advantageous tumbling effect of gas can be obtained in the combustion chamber 4 thereby providing conditions for a high degree of mixing between fuel and air inside the combustion chamber 4. Moreover, a high trapping efficiency of fuel inside the combustion chamber 4 can be obtained.

The scavenging port 22 provided in the wall of the cylinder 2 may also be referred to as a supplementary scavenging port. Likewise, the scavenging channel 24 which fluidly connects the pump chamber 8 to the scavenging port 22 may also be referred to as a supplementary scavenging channel.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A crankcase scavenged two-stroke engine comprising:
a cylinder,
a crankcase enclosing a crankcase volume
a crankshaft arranged at least partially inside the crankcase volume and
a piston connected to the crankshaft such that the piston reciprocates in the cylinder between a top dead centre and a bottom dead centre upon rotation of the crankshaft, wherein the piston comprises a first face forming a delimiting surface of a combustion chamber and a second face forming a delimiting surface of the crankcase volume
wherein the engine comprises a pump chamber with an aperture facing the second face of the piston the pump chamber being in direct fluid communication with the crankcase volume via the aperture when the piston is in a region of the top dead centre,
and wherein the piston comprises a section configured to protrude into the pump chamber via the aperture to delimit the pump chamber from the crankcase volume when the piston is at a predetermined position between the top dead centre and the bottom dead centre.

2. The engine according to claim 1, wherein the pump chamber is arranged at a first end of the cylinder.

3. The engine according to claim 1, wherein the pump chamber is at least partially formed by a pump chamber body attached to a first end of the cylinder.

4. The engine according to claim 3, wherein the pump chamber body is ring-shaped.

5. The engine according to claim 1, wherein the pump chamber is annular or arc-shaped.

6. The engine according to claim 1, wherein a radially outer wall of the pump chamber superimposes a radially outer wall of the cylinder as seen in a direction parallel to a cylinder axis of the cylinder.

7. The engine according to claim 1, wherein the section of the piston is a section of a piston skirt of the piston.

8. The engine according to claim 1, wherein the engine comprises a channel connected to the pump chamber, and wherein the section of the piston is configured to force gas from the pump chamber through the channel upon movement of the piston from the first predetermined position towards the bottom dead centre.

9. The engine according to claim 8, wherein the engine comprises a fuel supply system and wherein the channel fluidly connects the pump chamber and a portion of the fuel supply system.

10. The engine according to claim 9, wherein the fuel supply system comprises a fuel pump and wherein the portion of the fuel supply system is a portion of the fuel pump

11. The engine according to claim 10, wherein the fuel pump is a membrane pump comprising a flexible membrane and wherein the portion of the fuel supply system is a portion of the flexible membrane.

12. The engine according to claim 9, wherein the fuel supply system comprises at least one of a fuel injector configured to inject fuel into the crankcase volume a fuel injector configured to inject fuel into an air inlet duct connected to the crankcase volume and a fuel injector configured to inject fuel into a scavenging channel fluidly connecting the crankcase volume and the combustion chamber.

13. The engine according to claim 9, wherein the fuel supply system comprises a fuel injector configured to inject fuel into the combustion chamber.

14. The engine according to claim 9, wherein the fuel supply system comprises a pressure reservoir and wherein the portion of the fuel supply system is a portion of the pressure reservoir.

15. The engine according to claim 14, wherein the channel comprises a non-return valve.

16. The engine according to claim 14 or 15, wherein the fuel supply system is an air assisted direct injection system configured to inject fuel and air from the pressure reservoir into the combustion chamber of the engine.

17. The engine according claim 1, wherein the engine comprises a scavenging port in a wall of the cylinder, and a scavenging channel fluidly connecting the pump chamber and the scavenging port.

18. A handheld power tool comprising an the engine according claim 1.
